(19) United States
(12) Patent Application Publication
(10) Pub. No.: US 2003/0063305 A1
(43) Pub. Date: Apr. 3, 2003

(54) Method and system for saving and restoring printer control panel settings

(76) Inventor: C. Kevin McIntyre, Boise, ID (US)

Correspondence Address: HEWLETT-PACKARD COMPANY, Intellectual Property Administration, P.O. Box 272400, Fort Collins, CO, 80527-2400, US

(21) Appl. No.: 09/966,619

(22) Filed: Sep. 28, 2001

(51) Int. Cl. B41B 1/00; G06F 15/00

(52) U.S. Cl. 358/1.13

(57) ABSTRACT

A document production system for setting, controlling, querying and saving printer control settings is provided. Based upon user selected control settings for a single printer, control settings for multiple printers or groups of printers may be manually or automatically set to preserve the selected control settings.

### FIELD OF THE INVENTION

The present invention relates to systems and methods for customizing printer settings. More specifically, the present invention includes a document production system that facilitates creation, application, and preservation of customized printer control settings for one or more printers.

### BACKGROUND OF THE INVENTION

Printers, or other document production hardware, are typically pre-programmed at the time of manufacture with default device settings, such as print quality, paper size, and other common printer functions. These default settings may be altered on a printer-by-printer basis using a control panel integrated with the printer or with software provided to operate the printer. Altering the default settings for a number of printers, or other document production hardware, however, may be very time consuming and expensive.

Most printers allow a user to manually change the default settings using the printers' control panel. Typically, control panel settings are manually changed when the printer is new or when the firmware is upgraded to include new functionality, such as by a flash utility. The capability to create a desired default print configuration by customizing a printer's control panel settings is desirable because it allows the user to print documents in a desired format without having to reconfigure the printer each time a print job is executed. Moreover, the capability to set default settings for the printer produces consistency among documents and establishes an expectation of print quality. These benefits are particularly relevant in an enterprise environment where one or more identical printers or groups of printers are employed to serve substantially the same function.

Default settings or specific print job settings may also be altered using printer driver software. Graphical user interface (GUI) control panels typically provided with printer driver software allow users to temporarily change various print settings to create one or more desired customized print configurations. For example, a user may alter the default settings appearing on a printer driver or software GUI to customize the print options for that print job. Typical changes include changing to a landscape instead of portrait format, printing in duplex format instead of single page format, printing in a higher resolution than the original default setting, selecting a particular paper source as a default setting, and the like. These customized settings are typically lost, however, upon execution of the print job, the closing of the application, or by shutting off the user's workstation. Furthermore, default printer settings specific to an individual user may be defined using specialized software packages. However, such default settings only apply to print jobs originating from the machine operating the particular program. In some instances, the printer driver software may allow the user to change the default settings for print jobs originating from their machine. However, an individual user cannot control the default settings for the printer itself.

Generally, in order to create a desired default print configuration in one or more printers, the control panel settings of each printer must be individually adjusted. In order to preserve the customized control settings to achieve the desired default print configuration, such settings are often written to a non-volatile, programmable memory device incorporated into the firmware of the printer. Such memory devices typically include electrically erasable read-only-memory (EEPROM) or programmable read-only-memory (PROM). Use of non-volatile memory (NVRAM) for this process is advantageous since a loss of power to the printer, whether anticipated or unanticipated, will not result in a loss of successfully upgraded control panel settings. Typically, flash memory is updated using a Flash ROM Upgrade Utility in conjunction with a PC and parallel port connection, or via a PCMCIA Update card and PCMCIA Slot (if the printer is equipped for such), or over a network.

Writing a customized default print configuration into the firmware of a printer, however, is not without drawbacks. Specifically, existing printer configuration settings written in firmware will be lost upon execution of flash process used to update or replace the firmware. This may result in the loss of customized control panel settings, which can be reacquired only at a significant cost of human and material resources. Although the effort required to reprogram desired defaults on one or two printers may not be too significant, the reprogramming of multiple printers on a repetitive basis can become tedious.

For instance, in order to restore customized settings lost from the firmware of a state of the art printer during a flash process, each of the appropriate control panel settings must again be individually adjusted and set. Furthermore, before becoming aware that a customized configuration has been lost, one or more users may send several print jobs to the affected printer(s), resulting in a significant waste of user time and material resources due to an unacceptable print format. Therefore, the loss of customized default print settings due to a flash process, or other processes that erase the desired printer default settings, may result in significant costs to either an individual user or to an entire enterprise. As flash processes become more and more seamless or are applied to entire networks of printers, such costs will only increase.

Therefore, it would be an improvement in the art to provide a system whereby customized, default printer control panel settings are restored while minimizing losses in material or human resources resulting from changed default settings. Preferably, such a system would enable both automatic and manual restoration or reconfiguration of the control panel settings of one or more printers. Additionally, the ability to allow a user to restore or reconfigure the control panel settings of one or more printers without having to individually adjust the control panel settings of each of the affected printers is desirable.

### SUMMARY OF THE INVENTION

The present invention relates to systems and methods for customizing printer settings. More specifically, the present invention includes a document production system that facilitates creation, application, and preservation of customized printer control settings for one or more printers.

One embodiment of the document production system of the present invention includes a printer control program for communicating with one or more printers. The printer control program facilitates the storage and preservation of the control settings for the one or more printers in communication therewith. A group of customized printer control settings may be created using the printer control program and stored in an accessible media format, such as a configuration file readable by a computer or a printer. Each customized printer control setting may be assigned to a specific printer or a group of printers. The customized printer control settings included desired default control settings available for the given printer. Storing the customized printer control settings ensures that the settings can be recreated or reproduced should a printer's default settings be lost.

To change a printer's control settings, or restore the default control settings following a reconfiguration of a printer's firmware, the printer control program is invoked to download the desired setting to a printer. A manual command to update a printer's control settings prompts the printer control program to download a customized printer control setting associated with the given printer. The customized printer control setting received by the printer is written to, or stored within, the firmware of the printer, effectively updating the printer's control settings.

In another embodiment of the present invention, the printer control program is stored within, or is accessible to a computer. A user interacts with the printer control program through a graphical user interface displayed on the computer. The graphical user interface allows a user to create customized printer control settings in the same manner as printer driver software GUIs allow a user to set specific document properties for a single print job. In addition, the printer control program allows the user to assign customized printer control settings to individual printers and groups of printers in communication with the computer operating the printer control program. The customized printer control settings may be saved or applied to a printer or group of printers.

When applied to a printer, or other document production device, the customized printer control settings are written to the firmware of the device. When the customized printer control settings are written to a printer, the default settings for the printer control panel, if one exists, are also changed to match the customized printer control settings. Using the printer control program, a user may manually update a group of printers with the preferred customized printer control settings. Alternatively, the printer control program may automatically download customized printer control settings on a predefined schedule, such as daily and then distribute those settings to a designated set of accessible printers. Because a customized printer control setting may be assigned to a number of printers, the printer control program allows the restoration of all of the control settings for a number of printers at one time. Allowing an end user to create and apply customized printer control settings to one or more designated printers, the printer control program of the present invention greatly simplifies the task of creating and restoring customized printer control settings.

In yet another embodiment of the present invention, the printer control program includes a query function for querying the printer control settings of any printer in communication with the printer control program. Typically, a user accesses the query function with a computer executing a printer control program. A user invoking the query function of the printer control program may monitor the printer control settings and optionally change those settings if undesirable settings exist. If the monitored printer control settings differ from the desired control settings, the control settings may be changed using the printer control program. Alternatively, the printer control program may be instructed to download a customized printer control setting to restore the desired default settings to the monitored printer.

The present invention may also include an automated printer management function to facilitate maintenance of printer control settings. Firmware, or programs residing in a printer memory, may be updated on a regular basis to fix bugs or program additional features into the printer. Typically, the firmware is updated using a flash process, such as the replacement or rewriting of flash memory within the printer. The update process erases the printer control settings stored within the printer at the time of update. To prevent the loss of customized printer control settings on printers being updated, the printer control process may include a function that retrieves and stores all of the printer control settings for a printer or group of printers prior to updating. Following the update of the firmware, the printer control program restores the printer control settings to each printer by downloading the previously stored printer control settings to the respective printers. Thus, the printer control settings are maintained. This process may be automated so that the printer control program automatically query and save printer control settings before each firmware update.

### DESCRIPTION OF THE DRAWINGS

While the specification concludes with claims particularly pointing out and distinctly claiming that which is regarded as the present invention, the present invention can be more readily ascertained from the following description of the invention when read in conjunction with the accompanying drawings in which:

FIG. 1 illustrates a schematic diagram of one embodiment of the document production system of the present invention including a computer in communication with one or more printers;

FIG. 2 illustrates a schematic diagram of an alternate embodiment of the document production system of the present invention; and

FIG. 3 illustrates a block diagram of the steps involved in a printer management function of the present invention.

### DETAILED DESCRIPTION OF THE INVENTION

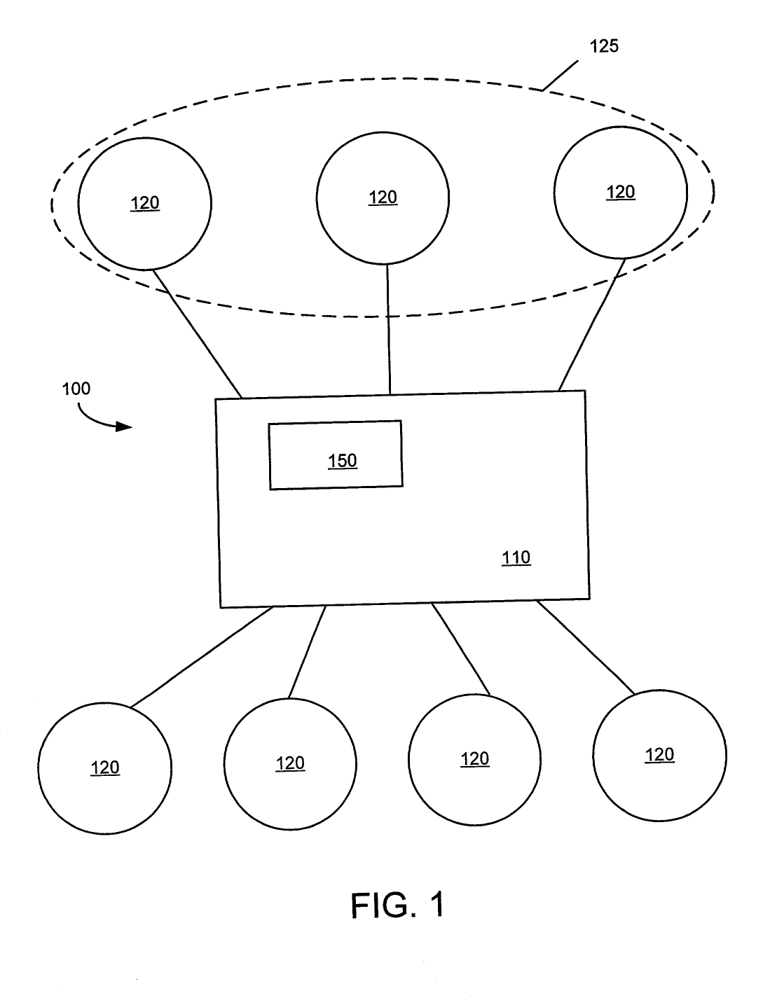

The present invention relates to systems and methods for customizing printer settings. More specifically, the present invention includes a document production system that facilitates creation, application, and preservation of customized printer control settings for one or more printers. Using a printer control program, the control settings, or customized settings, for one or more printer devices may be controlled and maintained. Multiple embodiments of the document production system and its use are further described with reference to FIGS. 1 thorough 3.

One embodiment of the document production system 100 of the present invention is schematically illustrated in FIG. 1. The document production system 100 includes a printer control program 150 resident on, or accessible to, a computer 110, or computing device. One or more printers 120, or printing devices, may be in operable communication with the computer 110. The printers 120 may be controlled by the printer control program 150 using computer 110.

Computer 110 may include any of a number of computing devices capable of sending or receiving data, such as stand-alone computers, palm computers, laptop computers, and the like. However, computer 110 is typically a stand-alone workstation or computer platform connected to a wide-area network, a local-area network, an intranet, or other network system having access to data storage, printers 120 and a printer control program 150. Computer 110 may also be connected to the document production system 100 through the Internet. Computer 110 generally includes a central processing unit for executing programs, such as the printer control program 150, a memory, a display device, a communications port for communicating with other computers or printers, and an input device.

Printers 120 may include any type of printing device used by computers, computing devices, or the like. Typically, printers 120 communicate with computer 110 and other computing devices using serial cables, parallel cables, SCSI ports, USB ports, IR ports, or other suitable wired or wireless communication technologies. For example, numerous printers 120 may be connected to a wireless or wired network system in an office situation. Individual printers 120 may be connected, or accessible to, a single computing device, or multiple computing devices, which make up the network system. Typically, the printers 120 include control panels that allow a user to manually alter the printer's 120 control settings.

The printer control program 150 of the document production system 100 facilitates the creation, storage and preservation of default and customized printer control settings for printers 120. In this embodiment of the document production system 100, the printer control program 150 includes a computer program that may be executed using computer 110. Once executed, the printer control program 150 presents the user with a set of options from which the control settings for each printer 120 associated with the document production system 100 may be set and/or controlled. Default, or customized, control settings for each individual printer 120 may be set and stored using the printer control program 150. Additionally, the printer control program 150 allows the user to define groups of printers 120 and associate an entire group 125 of printers 120 with a single set of control settings. Furthermore, the printer control program 150 allows the user to manually, or automatically, update the control settings for the printers 120 or group 125 of printers 120.

The control setting options presented to a user of the printer control program 150 are typically presented as a graphical user interface (GUI) as known in the art. The GUI may include standard GUI controls such as labels, text boxes, combo boxes, list boxes, check boxes, option buttons, toggle buttons, command buttons, tab strips, multi-page strips, command buttons, customized tools, and the like. However, it is understood that the printer control program 150 may also be controlled using other interaction techniques, such as command line processing, or text based option presentation. Regardless of the method used to present options to the user, the printer control program 150 allows the user to set and define default, or customized, control settings for printers 120 or groups 125 of printers 120.

For example, upon execution, the printer control program 150 presents the user with a GUI for defining control settings for a particular printer 120 or group 125 of printers 120. Upon selection of a particular printer 120 to control, the printer control program 150 determines the control settings available for that particular printer 120. The available control settings are typically stored as data that is available to the printer control program 150. This data may be accessed from a database associated with the printer control program 150, such as data stored in a memory of computer 110, or from a database stored or hardwired within the memory of the printer 120. The available control settings are displayed through the GUI. Typically, control settings include the various properties of the printer, such as the following: printer settings (number of copies, banner settings, orientation), paper options (size, source, optimizations), configuration (scaling, duplexing, memory), effects (watermarks, sizing), finishing (multisided printing, print quality), color management profiles, printer port settings, and the like. It is understood that any printer control settings may be set using the printer control program of the present invention. Using the GUI tools, the user is able to select the desired control settings. With the click of a command button, the selected control settings may be applied to the printer 120. The selected control settings may also be saved as a computer file for the particular printer 120 selected. Saved control settings are typically stored in a memory of computer 110, on a non-volatile storage media, or in a location accessible to the printer control program 150. The format of the saved control settings is such that either the printer control program 150 or a printer 120 may read and understand the saved control settings.

Typically, the printer control program 150 is used to individually assign control settings for individual printers 120 or groups 125 of printers. The assignments made by the printer control program 150 may be altered. For instance, many printers 120 include control panels integrated with the printer 120 to allow a user to alter the default control settings. Additionally, the control settings may be altered by individual software packages available on individual computers not associated with the document production system 100, but in communication with the printers 120. A user may choose to alter the control settings for a particular print job that they are executing. If the original control settings are not reprogrammed into the printer 120, all future print jobs will include the changed control settings. Furthermore, control settings programmed into the printers 120 are typically erased during firmware upgrades or flash memory upgrade processes. Such changes are often undesirable, especially in enterprise applications where multiple printers 120 may be affected.

The printer control program 150 eliminates some of the problems associated with changes or alterations made to the control settings of individual printers 120. A timed update function associated with the printer control program 150 automatically updates the control settings for an individual printer 120 or group 125 of printers 120. Using the printer control program 150, a user may choose to set a timed update for a printer 120 or group 125 of printers 120 at the time the control settings are saved. For example, a user, having set the control settings for a group 125 of printers 120, saves those control settings. At the time the user saves the control settings, the printer control program 150 may prompt the user to enter a time period for timed updates. The user may choose have the saved control settings updated hourly, daily, weekly, or on some other regular time schedule, as desired. Alternatively, the user may disable the timed update function. If a time period for timed updates is selected, the printer control program 150 automatically updates the control settings for the group 125 of printers 120 at the designated times. For instance, if a daily update is selected, the printer control program 150 may update the group 125 of printers 120 every morning so that the printers 120 are ready for use. Automatic timed updating helps to ensure that the printer control settings remain consistent.

The printer control program 150 of the document production system 100 also provides a time saving method for updating numerous printers 120 associated with an enterprise, or network, system. The printer control program 150 allows a network administrator to create a single control setting profile for a group 125 of printers 120. Once created and saved, the control settings for all of the printers 120 in the group 125 of printers 120 may be updated with the execution of an update command using the printer control program 150. This is especially valuable in those situations where the control settings for multiple printers 120 may need to be updated. For example, update of the firmware on multiple printers 120 associated with an enterprise network typically occurs using a flash process that also erases the control settings of each of the updated printers 120. Without the printer control program 150 of the present invention, the control settings for each individual printer 120 must be updated manually using the printer's 120 control panel. Where multiple printers 120 are involved, this is a very time consuming process. The printer control program 150 cuts down on the reprogramming time. Instead of manually reprogramming each printer 120, a user may execute an update command using the printer control program 150. The update command downloads saved control settings for the designated printer 120 or group 125 of printers 120. This allows all of the printers 120 to be updated at once, thus saving the time that it would take to manually reprogram all of the printers 120.

The printer control program 150 may also include a query function allowing a user to monitor the control settings for any given printer 120 at any time. Invoking the query function of the printer control program 150, a user may select a printer 120 or group 125 of printers 120 to monitor. The printer control program 150 then contacts the selected printer 120 or group 125 of printers 120 to ascertain the current control settings for the selection. The retrieved current control settings of the selected printer 120 or group 125 of printers 120 may be displayed on a GUI so the user may monitor those settings. If the control settings vary from the saved control settings, the user may choose to download the saved control settings to the selected printer 120 or group 125 of printers 120. For instance, a network administrator operating the printer control program 150 on a computer 110 may query the current control settings of a printer 120. Finding that the current control settings do not match the desired, or saved, control settings, the network administrator uses the printer control program 150 to change the current control settings in real-time. Alternatively, the network administrator may invoke the update function of the printer control program 150 to initiate a download of the saved control settings for the selected printer 120, effectively updating the control settings for the selected printer 120.

In addition, the query function of the printer control program 150 may be configured to automatically distinguish and highlight the differences between the current control settings for the selected printer 120 or group 125 of printers 120 from the saved control settings. To accomplish this task, the query function of the printer control program 150 connects with the selected printer 120 or group 125 of printers 120 to ascertain the current control settings. The saved control settings are then accessed and compared to the current control settings. If any differences exist between the current control settings and the saved control settings, the printer control program 150 brings the differences to the user's attention by highlighting, or providing a list of, the differences in the control settings. Thus, a user is able to quickly ascertain those portions of the current control settings that are not consistent with the saved control settings.

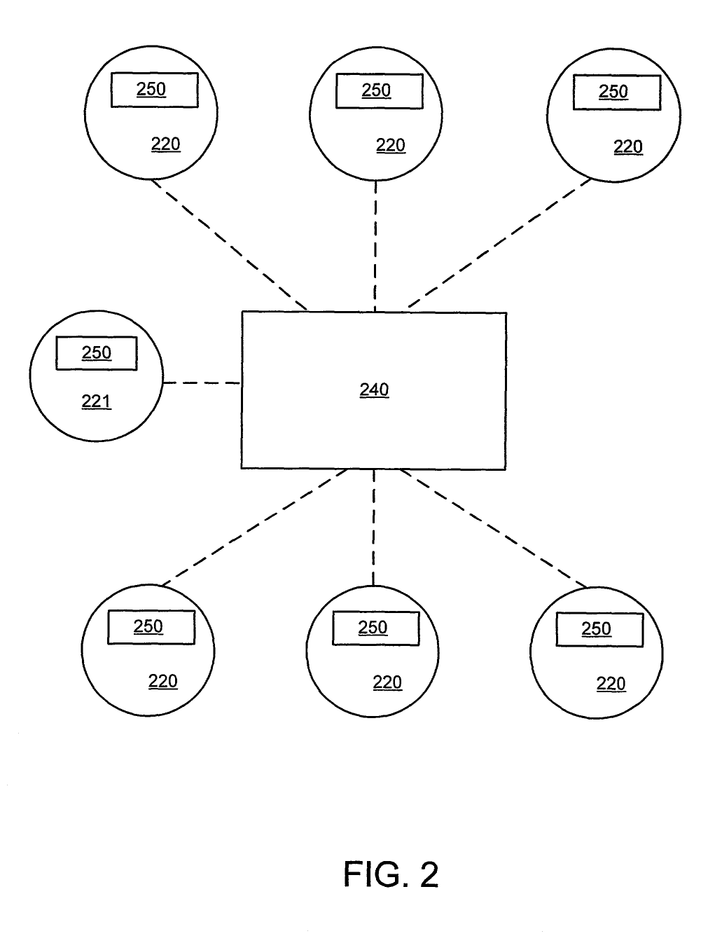

In another embodiment of the present invention, the document production system 200 does not include a computer allowing a user to access a printer control program. Instead, the printer control program 250 is resident within the memory or firmware of each printer 220. An example of this embodiment of the document production system 200 is illustrated in FIG. 2.

The control settings for a printer 220 may be programmed using a control panel associated with the printer 220 as known in the art. Once programmed, the printer control program 250 integrated into the firmware of the printer 220 allows a user to save the control settings to storage media 240 in a printer 220 readable formats. Storage media 240 may include such things as a floppy disk, a flash memory card, a hard drive, or other storage media commonly used to store data. This may also include a storage media 240 commonly accessible to more than one printer 220. Once stored, the saved control settings may be accessed by printer control programs 250 resident on other printers 220 having access to the storage media 240.

For instance, the control settings for a specific printer 221 are programmed using the specific printer's 221 control panel. Once programmed, the user accesses the printer control program 250 stored in the firmware of specific printer 221 to save the current control settings. The printer control program 250 prompts the user to select the storage media 240 desired. Because all of the printers 220, including specific printer 221, are connected to a storage media 240 associated with a computer network, the saved control settings may be stored on the storage media 240. Alternatively, the user could choose to store the control settings on a floppy disk or other readable/writeable media, if the specific printer 221 includes a mechanism to write to the readable/writeable media. Once saved, other printer control programs 250 may download the control settings from storage media 240. If the user saves the control settings to the storage media 240, the user may then access the printer control program 250 on one of the other printers 220 to download the saved control settings to that printer 220. Although this embodiment of the document production system 200 requires that a user manually access a printer control program 250 on each printer to update the control settings, time is still saved because the user only invokes a download routine on additional printers 220 once the control settings are saved to a storage media 240. Thus, all of the control settings need not be reprogrammed.

Alternatively, the printer control program 250 stored on specific printer 221 may include an updateable list of additional printers 220 capable of using the printer control program 250. In addition to using the control panel of specific printer 221 to set the control settings of the specific printer 221, a user may designate any of the additional printers 220 in the updateable list to apply the selected control settings to. Thus, the user may designate control settings for multiple printers 220 using the control panel of the specific printer 221.

In yet another embodiment of the present invention the printer control program includes an automated printer management function to facilitate automatic maintenance of printer control settings. The printer management function may be associated with either a printer control program 150 resident on a computer 110 or a printer control program 250 resident in the firmware of a printer 220.

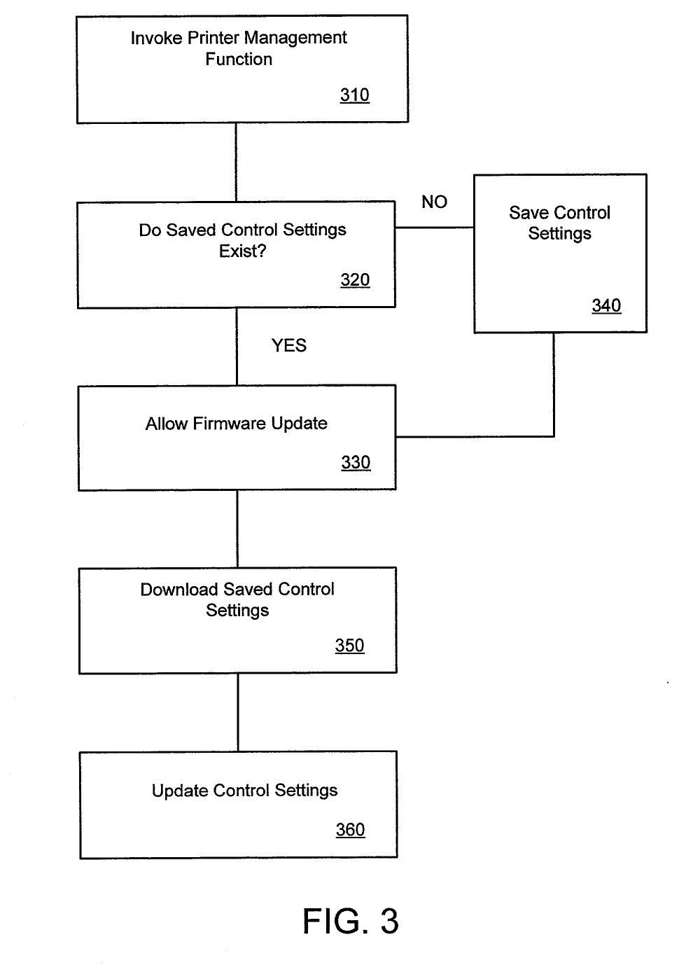

Upon a scheduled, or unscheduled, update of a printer's firmware, the printer management function of the present invention is invoked to ensure the maintenance of the desired control settings for the printer. The steps involved in the printer management function are illustrated in FIG. 3. The printer management function may be invoked 310 in one of two ways. A user may manually invoke 310 the printer management function before updating the firmware of a particular printer. Alternatively, the printer control program may be set such that the printer management function is automatically invoked 310 prior to a firmware update. Once invoked 310, the printer management function determines whether or not saved control settings exist 320 for the particular printer. If they exist, the printer management function allows the firmware update 330. If saved control settings do not exist, the printer management function determines the current control settings of the printer being updated and saves 340 them to a storage media remote to the printer. The printer management function then allows the firmware update 330. Following the firmware update 330, the printer management function retrieves the saved control settings and downloads 350 them to the printer. The control settings for the printer are then updated 360 based upon the downloaded control settings. In this manner, the printer management function ensures that printer control settings are not lost during firmware updates.

Having thus described certain preferred embodiments of the present invention, it is to be understood that the invention defined by the appended claims is not to be limited by particular details set forth in the above description, as many apparent variations thereof are possible without departing from the spirit or scope thereof as hereinafter claimed.

What is claimed is:

1. A method for saving and restoring printer control settings, comprising:
selecting control settings for a printer using a control panel of said printer;
executing a printer control program for determining said selected control settings for said printer; and
saving said selected control settings to a media storage device.

2. The method of claim 1, further comprising:
invoking a firmware update on said printer;
updating said firmware;
executing said printer control program for restoring said selected control settings;
downloading said saved selected control settings from said media storage device; and
updating said selected control settings to said printer.

3. The method of claim 1, further comprising:
using said control panel for selecting at least one additional printer to transfer said saved selected control settings to; and
updating control settings of said at least one additional printer with said saved selected control settings.

4. A method for saving and restoring printer control settings, comprising:
executing a printer control program for creating and saving printer control settings;
using said printer control program to select at least one printer associated with said printer control program;
retrieving available control settings for said at least one selected printer;
displaying said retrieved available control settings for selection by a user;
selecting desired control settings from said retrieved available control settings;
saving said selected desired control settings; and
updating said at least one selected printer with said desired control settings.

5. The method of claim 4, wherein executing a printer control program for creating and saving printer control settings comprises executing said printer control program using a computer.

6. The method of claim 4, wherein using said printer control program to select at least one printer associated with said printer control program comprises selecting a group of printers.

7. The method of claim 4, wherein retrieving available control settings for said at least one selected printer comprises retrieving said available control settings from said at least one selected printer.

8. The method of claim 4, wherein retrieving available control settings for said at least one selected printer comprises retrieving said available control settings from a database storing said available control settings.

9. The method of claim 4, wherein displaying said retrieved available control settings for selection by a user comprises displaying said retrieved available control settings on a display device in a graphical user interface format.

10. The method of claim 4, wherein updating said at least one selected printer with said desired control settings comprises updating control settings of said at least one selected printer on a predefined schedule.

11. The method of claim 4, wherein updating said at least one selected printer with said desired control settings comprises automatically updating control settings of said at least one selected printer following a firmware upgrade of said at least one selected printer.

12. A document production system for setting and maintaining printer control settings, comprising:
at least one printer for printing documents conforming to stored control settings stored in a memory of said at least one printer; and
a printer control program for retrieving control settings from said at least one printer, saving control settings, downloading control settings, and updating control settings in said memory of said at least one printer.

13. The document production system of claim 12, wherein said printer control program is resident in said memory of said at least one printer.

14. The document production system of claim 12, further comprising a storage media for receiving control settings from said printer control program for saving.

15. The document production system of claim 12, further comprising a storage media for providing said printer control program with control settings to download.

16. The document production system of claim 12, wherein said printer control program further comprises a function for automatically updating control settings of said at least one printer following firmware updates of said at least one printer.

17. The document production system of claim 12, further comprising a computer for executing said printer control program.

18. The document production system of claim 17, wherein said computer comprises:
a central processing unit for executing said printer control program;
a storage media for storing said printer control program;
a display device for displaying control settings retrieved from said at least one printer;
an input device for selecting desired control settings retrieved from said at least one printer; and
a communication link for communicating with said at least one printer.

19. The document production system of claim 17, wherein said printer control program further comprises a function for manipulating control settings of said at least one printer.

20. The document production system of claim 17, wherein said printer control program further comprises a function for automatically updating control settings of said at least one printer following firmware updates of said at least one printer.
